(19) United States
(12) Patent Application Publication
(10) Pub. No.: US 2026/0265519 A1
(43) Pub. Date: Sep. 10, 2026

(54) CURABLE RESIN COMPOSITION WITH ADJUSTABLE ADHESION PROPERTIES AND METHODS THEREOF

(71) Applicant: Kaneka Americas Holding, Inc., Pasadena, TX (US)

(72) Inventors: Ruolei Wang, Pasadena, TX (US); Shota Koya, Pasadena, TX (US); Jonathan Barrus, Pasadena, TX (US); Yoshiki Nakagawa, Pasadena, TX (US)

(73) Assignee: Kaneka Americas Holding, Inc., Pasadena, TX (US)

(21) Appl. No.: 19/471,324

(22) PCT Filed: Mar. 29, 2024
(86) PCT No.: PCT/US2024/022194

§ 371 Date: Sep. 30, 2025

Related U.S. Application Data
(60) Provisional application No. 63/455,932, filed on Mar. 30, 2023.

(51) Int. Cl. C08L 71/08; C08G 65/336; C08G 77/08; C08J 3/20; C08K 3/22; C08K 3/26; C08K 5/3435; C08K 5/3475; C08K 5/5425; C08K 5/544

(52) U.S. Cl. CPC C08L 71/08; C08G 65/336; C08G 77/08; C08J 3/203; C08K 3/26; C08K 5/3435; C08K 5/3475; C08K 5/5425; C08K 5/544; C08J 2371/02; C08J 2471/02; C08K 2003/2241; C08K 2003/265; C08L 2205/03; C08L 2205/05

(57) ABSTRACT

A curable resin composition, including at least one moisture curable resin and at least one polyol plasticizer is provided. The polyol plasticizer has at least one ethylene oxide moiety. A method for producing a curable resin composition includes mixing 5 wt % to 70 wt % of at least one moisture curable resin and 0.5 wt % to 40 wt % of a polyol plasticizer.

### BACKGROUND

A curable resin composition is often used as a coating material to protect a structure. Such compositions may include a moisture curable resin and a plasticizer. Curable resin compositions which use standard plasticizers such as benzoate, glycol diester, or phthalate plasticizers adhere tightly to substrates preventing removal. Strong adhesion to a substrate is often a desired property of curable resin compositions. However, in some applications it may be advantageous to separate the cured resin composition from the substrate.

Removal of standard cured resin coating materials may result in damage to the substrate, as well as increased time and labor spent on the removal. Accordingly, there exists a need for continuing improvement of a curable resin composition possessing a removable adhesion property.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a curable resin composition, including at least one moisture curable resin and at least one polyol plasticizer. The polyol plasticizer has at least one ethylene oxide moiety.

In another aspect, embodiments disclosed herein relate to a method for producing a curable resin composition. The method includes mixing 5 wt % to 70 wt % of at least one moisture curable resin and 0.5 wt % to 40 wt % of a polyol plasticizer.

Other aspects and advantages of the claimed subject matter will be apparent from the following description and the appended claims.

### DETAILED DESCRIPTION

Curable resins are often used as a coating material to protect various structures. They generally possess strong adhesion properties that prevent removal of the coating. However, in some applications it may be advantageous to be able to readily remove the cured resin composition from the structure at a period of time after curing. That is, upon curing, the resin composition may function as a sealant, adhesive, barrier, etc. for a period of time, but may be easily removed when such function is no longer needed. The present disclosure generally relates to a curable resin composition with a removeable adhesion property, imparted from the inclusion of a polyol plasticizer. The curable resin composition includes at least one curable resin and a polyol plasticizer that has ethylene oxide capping groups.

### Moisture Curable Resin

In one or more embodiments, the curable resin composition includes at least one moisture curable resin. The moisture curable resin may be a polymer which contains functional groups that are reactive with moisture or water. In one or more embodiments, the moisture curable resin includes reactive silicone groups, such as silyl-terminated polyether and silane-terminated polyurethane, or other types of silane modified polymers.

A specific structure of the reactive silicon groups is not specifically limited, but may include reactive silicon groups represented by the general formula (1):

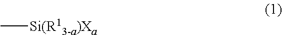

where R¹ represents an alkyl group having 1 to 20 carbon atoms, an aryl group having 6 to 20 carbon atoms, or an aralkyl group having 7 to 20 carbon atoms, X represents a hydrolyzable group, wherein each X is the same or different when two or more X are present, a is an integer from 1 to 3, when a is 1, each R¹ may be the same or different, and when a is 2 or 3, each X may be the same or different.

In one or more embodiments, the moisture curable resin includes trimethoxysilyl, methyldimethoxysilyl, triethoxysilyl, methyldiethoxysilyl groups, or combinations thereof. Examples of the moisture curable resin are described in U.S. application Ser. No. 17/434,612, which is incorporated by reference herein in its entirety.

Specific examples of the moisture curable resin may include, but are not limited to, KANEKA MS POLYMER® S303H, S327, S227, and S203, and KANEKA SILYL® SAX220, SAX520, SAX530, SAT145, and SAT115.

In one or more embodiments, the amount of the moisture curable resin in the curable resin composition is in a range of from about 10 wt % to about 70 wt % based on the total weight of the curable resin composition, such as a lower limit selected from any one of 10, 15, 20, 25, 30, 35, 40, 45 and 50 wt %, to an upper limit selected from any one of 40, 45, 50, 55, 60 65, and 70 wt %, where any lower limit may be paired with any mathematically compatible upper limit.

### Polyol Plasticizer

In one or more embodiments, the curable resin composition includes at least one polyol plasticizer. At least one polyol plasticizer includes at least one ethylene oxide moiety. Suitable polyol plasticizers may include, but are not limited to polyether diols, polyether triols, polyether tetrols, and combinations thereof. The ethylene oxide moiety of the polyol plasticizer may be located at a terminal end of the polymer chain, along the polymer chain between the terminal ends, or both. Examples of the polyol plasticizer include polyols having the formulas (2) and (3):

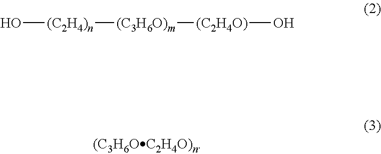

In one or more embodiments, the polyol plasticizer may have a number of ethylene oxide moieties in a range from about 1 mol % to about 60 mol %, such as a lower limit selected from any one of 1, 2, 5, 10, 15, 20, 25, and 30 mol % to an upper limit selected from any one of 35, 40, 45, 50, 55, and 60 mol % where any lower limit may be paired with any upper limit.

In one or more embodiments, the polyol plasticizer may yield a hydroxyl number in a range from about 10 to about 400 mg·KOH/g, such as a lower limit selected from any one of 10, 20, 30, 50, 75, 100, 150, and 200, to an upper limit selected from any one of 150, 200, 250, 300, 350, and 400, where any lower limit may be paired with any mathematically compatible upper limit. The hydroxyl value may be determined using titration methods known in the art. In particular, the hydroxyl value may be determined from the milligrams of potassium hydroxide required to neutralize any acid when combined by acetylation of 1 gram of the substance.

In one or more embodiments, the polyol plasticizer may have linear or branched structures, and the number-average molecular weight (Mn) may be in a range of from about 500 to about 10,000 Dalton (Da), such as a lower limit selected from any one of 500, 1,000, 1,500, 2,000, 2,500, and 3,000 Da to an upper limit selected from any one of 4,000, 5,000, 6,000, 7,000, 8,000, 9,000, and 10,000 where any lower limit may be paired with any upper limit. Commercially available examples of suitable polyol plasticizers include POLY-G® 22-37 and POLY-G® 55-37 available from Monument Chemical, and PGP-2012, PGP-2816, and GP-4520 from Carpenter Chemical.

In one or more embodiments, the amount of the polyol plasticizer in the curable resin composition is in a range of from about 0.5 wt % to about 40 wt % based on the total weight of the curable resin composition, such as a lower limit selected from any one of 0.5, 1, 2, 4, 5, 10, 15, 20, 15, 30, and 35 wt %, to an upper limit selected from any one of 20, 30, and 40 wt %, where any lower limit may be paired with any mathematically compatible upper limit.

In one or more embodiments, a combined content of the moisture curable resin and the polyol plasticizer in the curable resin compositions is in a range of about 5 wt % to about 90 wt % based on the total weight of the curable resin composition, such as a lower limit selected from any one of 5, 10, 20, 25, 30, 35, 40, 45, and 50 wt %, to an upper limit selected from any one of 45, 50, 55, 60, 65, 70, 75, 80, 85, and 90 wt %, where any lower limit may be paired with any mathematically compatible upper limit.

### Additional Plasticizer

In one or more embodiments, the curable resin composition includes an additional plasticizer, also referred to as a co-plasticizer. Suitable additional plasticizers may include, but are not limited to, polyols that do not include the previously described ethylene oxide moiety. An example of such a polyol plasticizer is POLY-G® 20-37, a polypropylene glycol available from Monument Chemical. Other additional plasticizers may include, but are not limited to, phthalates and non-phthalate esters such as DINCH or Mesamol.

In one or more embodiments, the amount of the additional plasticizer in the curable resin composition is in a range of from about 1 wt % to about 40 wt % based on the total weight of the curable resin composition, such as a lower limit selected from any one of 1, 2, 5, and 10 wt %, to an upper limit selected from any one of 10, 20, 30, 35, and 40 wt %, where any lower limit may be paired with any upper limit.

### Additives

In one or more embodiments, the curable resin composition includes additives. The curable resin composition may include any suitable additives, such as fillers, pigments, thixotropic agents (anti-sagging agents), UV inhibitors/absorbers, stabilizers, antioxidants, dehydration agents, flame retardants, curability modifiers, lubricants, antifungal agents, surfactants, and combinations thereof.

Examples of the fillers may include, but are not limited to, ground and precipitated calcium carbonate (CaCO₃), magnesium carbonate, diatomite, calcined clay, clay, talk bentonite, reinforcing fillers such as fumed silica, precipitated silica, crystalline silica, and fibrous fillers such as glass fibers and filaments. Specific examples of the CaCO₃ filler may include Hubercarb®Q3T, Hubercarb®G2T and Hubercarb®G8 available from Huber Engineered Materials.

Examples of pigments may include, but are not limited to, titanium dioxide (TiO₂) and carbon black.

Examples of thixotropic agents may include, but are not limited to, hydrogenated castor oil, organic amid wax, organic bentonite and calcium stearate.

Examples of UV inhibitors/absorbers may include, but are not limited to, benzophenone compounds, benzotriazole compounds, salicylate compounds, substituted tolyl compounds and metal chelate compounds.

Examples of stabilizers may include, but are not limited to, hindered amine light stabilizer (HALS), benzotriazole compounds, and benzoate compounds.

Examples of antioxidants may include, but are not limited to, hindered phenolic antioxidants such as Irganox®245, 1010, and 1076, available from BASF.

Examples of dehydration agents may include, but are not limited to, alkoxysilane compounds such as n-propyl trimethoxy silane, vinyl trimethoxy silane and octyl trimethoxy silane.

In one or more embodiments, the amount of the additives in the curable resin composition is in a range of from about 0 wt % to about 90 wt %, such as a lower limit selected from any one of 0, 1, 5, 10 and 20 wt %, to an upper limit selected from any one of 30, 40, 50, 60, 70, 80, and 90 wt %, where any lower limit may be paired with any upper limit.

In one or more embodiments, the amount of the filler in the curable resin composition is in a range of from about 0 wt % to about 80 wt %, such as a lower limit selected from any one of 0, 1, 5, 10, 20, 30, and 40 wt %, to an upper limit selected from any one of 40, 50, 60, 70, and 80 wt %, where any lower limit may be paired with any upper limit.

In one or more embodiments, the amount of the pigment in the curable resin composition is in a range of from about 0 wt % to about 20 wt %, such as a lower limit selected from any one of 0, 0.5, 1, 1.5, 2, 2.5, 3 and 4 wt %, to an upper limit selected from any one of, 5, 5.5, 7.5, 10, 12, 15, and 20 wt %, where any lower limit may be paired with any mathematically compatible upper limit.

In one or more embodiments, the amount of the thixotropic agent in the curable resin composition is in a range of from about 0 wt % to about 5 wt %, such as a lower limit selected from any one of 0, 0.1, 0.2, 0.5, and 1 wt %, to an upper limit selected from any one of 1.5, 2, 2.5, 3, 3.5, 4, 4.5, and 5.0 wt %, where any lower limit may be paired with any upper limit.

In one or more embodiments, the amount of the stabilizer in the curable resin composition is in a range of from about 0 wt % to about 3 wt %, such as a lower limit selected from any one of 0, 0.1, and 0.2 wt %, to an upper limit selected from any one of 0.5, 1, 2, and 3 wt %, where any lower limit may be paired with any upper limit.

In one or more embodiments, the amount of the dehydration agent in the curable resin composition is in a range of from about 0 wt % to about 5 wt %, such as a lower limit selected from any one of 0, 0.1, 0.2, 0.5, and 1 wt %, to an upper limit selected from any one of 1, 2, 3, 4, and 5 wt %, where any lower limit may be paired with any upper limit.

In one or more embodiments, the amount of the adhesion promoter in the curable resin composition is in a range of from about 0 wt % to about 5 wt %, such as a lower limit selected from any one of 0, 0.01, 0.02, 0.03, 0.04, 0.1, and 0.5 wt %, to an upper limit selected from any one of 0.5, 0,7, 0.8, 1, 2, 3, 4, and 5 wt %, where any lower limit may be paired with any upper limit.

### Properties—Curable Resin Composition

The curable resin composition described herein may have suitable properties for various applications. For example, the composition may have a suitable viscosity for applying to various surfaces via spraying, roller-applied coating, or extrusion through a caulking gun.

In one or more embodiments, the curable resin composition has a viscosity of less than 10,000,000 cP at 2 rpm, as measured by a rotational viscometer. The viscosity of the curable resin composition by a rotational viscometer (Brookfield HA/HB viscometer) is measured at a temperature of 23° C. with HA/HB-07 spindle. In one or more embodiments, the curable resin composition has a viscosity in a range of from about 1,000 to about 10,000,000 cP at 2 rpm, as measured by a rotational viscometer, such as in a range of from a lower limit selected from any one of 1,000, 125,000, and 150,000 cP, to an upper limit selected from any one of U.S. Pat. Nos. 2,400,000, 2,600,000, 5,000,000 and 10,000,000 cP, where any lower limit may be paired with any upper limit.

In one or more embodiments, the curable resin composition has a viscosity of less than 5,000,000 cP at 4 rpm, as measured by a rotational viscometer. In one or more embodiments, the curable resin composition has a viscosity in a range of from about 500 to about 5,000,000 cP at 4 rpm, as measured by a rotational viscometer, such as in a range of from a lower limit selected from any one of 500, 1,000, 90,000, 100,000, and 110,000 cP, to an upper limit selected from any one of U.S. Pat. Nos. 1,500,000, 1,600,000, 2,000,000 cP, and 5,000,000 cP, where any lower limit may be paired with any upper limit.

In one or more embodiments, the curable resin composition has a viscosity of less than 2,50,000 cP at 10 rpm, as measured by a rotational viscometer. In one or more embodiments, the curable resin composition has a viscosity in a range of from about 100 to about 2,500,000 cP at 10 rpm, as measured by a rotational viscometer, such as in a range of from a lower limit selected from any one of 100, 1,000, 85,000, and 90,000 cP, to an upper limit selected from any one of 600,000, 625,000, and 2,500,000 cP, where any lower limit may be paired with any upper limit.

In one or more embodiments, the curable resin composition has a skin time of less than 800 minutes at 23° C. and 50% relative humidity (RH). A “skin time” refers to a time required for the curable resin composition exposed to moisture-containing air to develop a film on the surface exposed to the air. In one or more embodiments, the curable resin composition has a skin time at 23° C. and 50% RH in a range from about 5 minutes to about 800 minutes, such as in a range of from a lower limit selected from any one of 5, 10, 20, 30, 40, 45, and 50, to an upper limit selected from any one of 90, 100, 150, 200, 250, 300, and 800 minutes, where any lower limit may be paired with any upper limit.

### Properties—Cured Resin Composition

Once the curable resin composition described above is cured, it may possess necessary mechanical properties such as hardness and tensile strength. The composition is considered as cured when upon handling with force, no material transfer occurs, and material develops the majority of targeted mechanical properties such as tensile/elongation strength, hardness. Additionally, once applied to a surface and cured, the cured composition may exhibit good adhesion to the surface until desired removal. Once removal of the cured resin is desired, it may be removed easily without leaving behind a residue or causing substrate damage. The curable resin composition described above may be cured by being exposed to moisture in the ambient environment to produce the cured resin composition. As such, the resins described herein may be cured under ambient conditions, for example.

In one or more embodiments, a cured resin composition of the curable resin composition has an adjustable adhesion property. The adhesion property may be adjusted to provide desired adherence to a substrate so that in some instances, the composition may adhere more strongly to a substrate than in other instances where a weaker adherence is desired. For example, in one or more embodiments, the cured resin composition may be adjusted to have a removeable adhesion property. As used herein, a removable adhesion property means the cured resin composition may be removed easily without leaving behind a residue or causing substrate damage. The cured resin composition may exhibit this adjustable adhesion property on a variety of substrates including but not limited to mortar, aluminum, stainless steel, glass, PVC, PC, ABS and various wood substrates.

In one or more embodiments, a cured resin composition of the curable resin composition has a tensile stress at 100% elongation of at least 0.03 MPa when tested according to ASTM D412. In one or more embodiments, the cured resin composition has a tensile stress at 100% elongation (M100) in a range of from about 0.03 to about 5 MPa, such as in a range of from a lower limit selected from any one of 0.03, 0.05, 0.13, 0.14, 0.15, and 0.16 MPa, to an upper limit selected from any one of 1, 2, 3, 4, and 5 MPa, where any lower limit may be paired with any upper limit.

In one or more embodiments, the cured resin composition of the curable resin composition has a tensile strength at break of at least 0.2 MPa when tested according to ASTM D412. In one or more embodiments, the cured resin composition has a tensile strength at break in a range of from about 0.2 to about 10 MPa, such as in a range of from a lower limit selected from any one of 0.2, 0.3, 0.4, 0.5, and 0.6 MPa, to an upper limit selected from any one of 6, 7, 8, 9, and 10 MPa, where any lower limit may be paired with any upper limit.

In one or more embodiments, the cured resin composition of the curable resin composition has a tensile elongation at break of at least 30% when tested according to ASTM D412. In one or more embodiments, the cured resin composition has a tensile elongation at break in a range of from about 30 to about 800%, such as in a range of from a lower limit selected from any one of 30, 50, 300, 400, and 500%, to an upper limit selected from any one of 500, 600, 700 and 800%, where any lower limit may be paired with any upper limit.

### Method for Producing a Curable Resin Composition

In another aspect, embodiments disclosed herein relates to a method for producing the previously described curable resin composition. The method may include mixing about 5 wt % to about 70 wt % of at least one moisture curable resin with about 1 wt % to about 40 wt % of a polyol plasticizer.

The mixing may be conducted with a method and equipment known in the art. In one or more embodiments, the mixing may be conducted using external mixing, airless external mixing, air-driven internal mixing, airless internal mixing, or a two-pot system. For example, single shaft, dual shaft or tri-shaft mixers may be used. The mixer style can be planetary or high speed disperse, with or without vacuum. The mixing may be conducted at a temperature in a range of from about 30° C. to 150° C.

### Structure

The present disclosure also relates to a structure including a substrate and a coating disposed on the structure. The coating may include at least one layer of the cured resin composition of the curable resin composition as previously described, and the number of layers may be determined based on the requirements of each application. In one or more embodiments, the coating includes a single layer of the cured resin composition. The single layer of the cured resin composition may function as a primer and a base coat. In one or more embodiments, the coating includes a top coat disposed on the single layer of the cured resin composition. The top coat may be disposed on the surface that is opposite from the surface in contact to the substrate.

Examples of the substrate may include, but are not limited to, a fiberboard, oriented strand board (OSB) plywood, gypsum board, or other types of building sheathing board for residential, commercial, institutional construction, and other common construction materials such as sidings, glass, metal, wood, mortar/concrete, and stones.

As noted above, the coating may be advantageously removed from the substrate with little effort. The coating may be removed by hand without causing damage to the substrate or leaving a visible residue.

### Examples

The following examples are provided to illustrate embodiments of the present disclosure. The examples are not intended to limit the scope of the present invention, and they should not be so interpreted.

Curable resin compositions EXAMPLES 1-11 and COMPARATIVE EXAMPLE 1 were produced by mixing moisture curable resin(s), polyol plasticizer(s), catalyst(s) and various additives as shown in Table 1, 2 and 3. The liquid component including moisture curable resin, polyol plasticizers, and co-plasticizers was added into the mixer first. Once a homogenous state was reached, the solid components in the additives were charged into the mixer. After the material reaches a homogenous state, vacuum and heat were applied to facilitate the moisture removal. Once the product reached the desired QC parameters, the batch was finished with the addition of moisture scavenger, adhesion promoter and catalyst.

TABLE 1

| | | Example 1 | Example 2 | Example 3 | Example 4 |
|---|---|---|---|---|---|
| | | Paste | Paste | Coating | Coating |
| | | 50/50 | 30/70 | 50/50 | 30/70 |
| MS Polymer | S303H | 100 | 100 | 100 | 100 |
| | SAX350 | | | | |
| | SAX590 | | | | |
| | SAX530 | | | | |
| Plasticizer | Poly-G 20-37 | 50 | 30 | 50 | 30 |
| | Poly-G 55-37 | 50 | 70 | 50 | 70 |
| | DPHP | | | | |
| Calcium carbonate | UltraPflex | 100 | 100 | 25 | 25 |
| | G8 | 250 | 250 | 225 | 225 |
| | Aktifit VM | | | | |
| Titanium oxide | Ti-Pure R902+ | 10 | 10 | 10 | 10 |
| Rheology modifier | Crayvallac SLX | 2 | 2 | | |
| | Fumed Silica N-20 | | | | |
| UVA | Tinuvin 328 | 1 | 1 | 1 | 1 |
| HALS | Tinuvin 770 | 1 | 1 | 1 | 1 |
| Dehydration agent | VTMO | 7 | 7 | 6 | 6 |
| Adhesion promoter | MEMO | | | | |
| Catalyst | U-220H | 4 | 4 | 4 | 4 |

| | | | | |
|---|---|---|---|---|
| Total | 575 | 575 | 472 | 472 |
| Polymer (wt %) | 17.4 | 17.4 | 21.2 | 21.2 |

TABLE 2

| | | | Example 6 | Example 7 | Example 8 | |
|---|---|---|---|---|---|---|
| | | Example 5 | 85/15 | 70/30 | 70/30 | Example 9 |
| | | 85/15 | 0.5 phr 1124 | 0.25 DAMO | 0.5 phr 1124 | 70/30 |
| MS Polymer | S303H | 100 | 100 | 100 | 100 | 100 |
| Plasticizer | Poly-G 20-37 | 85 | 85 | 70 | 70 | 70 |
| | Poly-G 55-37 | 15 | 15 | 30 | 30 | 30 |
| Calcium carbonate | UltraPflex | 100 | 100 | 100 | 100 | 100 |
| | G8 | 250 | 250 | 250 | 250 | 250 |
| Titanium oxide | Ti-Pure R902+ | 10 | 10 | 10 | 10 | 10 |
| Rheology modifier | Crayvallac SLX | 2 | 2 | 2 | 2 | 2 |
| UVA | Tinuvin 328 | 1 | 1 | 1 | 1 | 1 |
| HALS | Tinuvin 770 | 1 | 1 | 1 | 1 | 1 |
| Dehydration agent | VTMO | 7 | 7 | 7 | 7 | 7 |
| Adhesion promoter | DAMO-T | | | 0.25 | | |
| | Dynasylan 1124 | | 0.5 | | 0.5 | |
| Catalyst | U-220H | 4 | 4 | 4 | 4 | 4 |

| | | | | | |
|---|---|---|---|---|---|
| Total | 575 | 575.5 | 575.25 | 575.5 | 575 |
| Polymer (wt %) | 17.4 | 17.4 | 17.4 | 17.4 | 17.4 |

TABLE 3

| | | Comparative | | |
|---|---|---|---|---|
| | | example 1 | Example 10 | Example 11 |
| MS Polymer | S303H | 100 | 100 | 100 |
| Plasticizer | Poly-G 20-37 | 100 | 100 | 95 |
| | Poly-G 55-37 | | | 5 |
| Calcium carbonate | UltraPflex | 100 | 100 | 100 |
| | G8 | 250 | 250 | 250 |
| Titanium oxide | Ti-Pure R902+ | 10 | 10 | 10 |
| Rheology modifier | Crayvallac SLX | 2 | 2 | 2 |
| UVA | Tinuvin 328 | 1 | 1 | 1 |
| HALS | Tinuvin 770 | 1 | 1 | 1 |
| Dehydration agent | VTMO | 7 | 7 | 7 |
| Adhesion promoter | DAMO-T | 5 | | |
| | Dynasylan 1124 | | | |
| Catalyst | U-220H | 2 | 4 | 4 |

| | | | |
|---|---|---|---|
| Total | 578 | 575 | 575 |
| Polymer (wt %) | 17.3 | 17.4 | 17.4 |

“S303H” of Table 1 is a moisture-curable silyl-terminated polyether Silyl® S303H (dimethoxysilane (DMS) MS Polymer™) resin available from Kaneka Corporation.

“Poly-G 20-37” and “Poly-G 55-37” in Table 1 are polyol plasticizers available from Monument Chemical as described above, polyether diol and ethylene oxide-capped diol, respectively. Poly-G 20-37 and Poly-G 55-37 have average molecular weights of 3,000 g/mol.

The descriptions and the supplier information of various additives in Table 1 is as follows:
Precipitated CaCO₃: Ultra Pflex® available from Minerals Technologies Inc.;
Ground CaCO₃: Hubercarb® G8 available from J. M. Huber Corporation;
Titanium Dioxide: Ti-Pure™ available from Chemours Company;
Thixotropic agent: Crayvallac® available from Arkema SA;
UV absorber: Tinuvin® 328 available from BASF SE;
Hindered amine light stabilizer (HALS): Tinuvin® 770 available from BASF SE;
Dehydration agent: vinyltrimethyoxysilane (VTMO);
Organotin Catalyst: NEOSTANN U-220H available from Nitto Kasi Co., Ltd.

### Physical Properties—Uncured Resin Compositions

Various physical properties of the uncured resin compositions of EXAMPLES 1-11 and COMPARATIVE EXAMPLE 1 were measured as described below.

Dynamic viscosity of the resin compositions was measured by a Brookfield rotational viscometer (“HA/HB” or “Brookfield” viscosity) with an 07 spindle. The viscosity was measured at a frequency of 2 rpm, 4 rpm, and 10 rpm. The Brookfield Thixotropic Index value of each resin composition was determined by dividing the HA/HB viscosity at 2 rpm by the HA/HB viscosity of the same resin composition at 10 rpm.

A skin time of the resin composition was determined by placing the resin composition on a substrate, and measuring the time required for a skin to form under 23° C. and 50% relative humidity (RH) condition. The skin time test was conducted on the resin compositions immediately after the compounded components were applied, and the skin time was determined by lightly touching the applied product surface with a sample spatula. The skin time is reached when no material transfer occurs to the spatula with light contact.

The summary of the uncured resin composition properties of EXAMPLES 1-11 and COMPARATIVE EXAMPLE 1 are shown in Table 4, 5 and 6.

TABLE 4

| | | | Example 1 | | Example 2 | | Example 3 | | Example 4 | |
|---|---|---|---|---|---|---|---|---|---|---|
| | | | 50/50 | | 30/70 | | 50/50 | | 30/70 | |
| | | | Before | After | Before | After | Before | After | Before | After |
| Viscosity (HA) | 2 rpm | cp | 924,000 | 2,592,000 | 976,000 | 2,776,000 | 57,000 | 116,800 | 61,200 | 125,600 |
| #7 | 4 rpm | cp | 568,000 | 1,584,000 | 594,000 | 1,652,000 | 44,700 | 92,800 | 48,000 | 100,800 |
| coating RV/#7 | 10 rpm | cp | 311,200 | 609,600 | 324,000 | 608,000 | 36,950 | 77,600 | 39,700 | 85,600 |

| | | | | | | | | | |
|---|---|---|---|---|---|---|---|---|---|
| Skin Formation Time | min. | 50 | 49 | 49 | 55 | 80 | 40 | 79 | 50 |

TABLE 5

| | | | Example 5 | | Example 6 | | Example 7 | | Example 8 | | Example 9 | |
|---|---|---|---|---|---|---|---|---|---|---|---|---|
| | | | 85/15 | | 85/15 w/1124 | | 70/30 w/DAMO | | 70/30 w/1124 | | 70/30 | |
| | | | Before | After | Before | After | Before | After | Before | After | Before | After |
| Viscosity | 2 rpm | cp | 1,020,000 | 1,408,000 | 936,000 | 1,435,000 | 896,000 | 1,392,000 | 928,000 | 1,520,000 | 912,000 | 1,572,000 |
| (HA) | 4 rpm | cp | 606,000 | 878,000 | 556,000 | 892,000 | 538,000 | 882,000 | 554,000 | 954,000 | 540,000 | 978,000 |
| #7 | 10 rpm | cp | 323,200 | 500,000 | 296,800 | 512,000 | 292,000 | 487,200 | 293,600 | 545,600 | 291,200 | 557,600 |

| | | | | | | | | | | | |
|---|---|---|---|---|---|---|---|---|---|---|---|
| Skin Formation Time | min. | 40 | 35 | 40 | 35 | 60 | 40 | 60 | 40 | 55 | 40 |

TABLE 6

| | | | Comparative example 1 | | Example 10 | | Example 11 | |
|---|---|---|---|---|---|---|---|---|
| | | | Before | After | Before | After | Before | After |
| Viscosity (HA) | 2 rpm | cp | 880,000 | 980,000 | 980,000 | 1,764,000 | 912,000 | 1,624,000 |
| #7 | 4 rpm | cp | 518,000 | 596,000 | 556,000 | 1,100,000 | 548,000 | 1,062,000 |
| | 10 rpm | cp | 287,200 | 345,600 | 294,400 | 633,600 | 293,600 | 616,000 |

| | | | | | | | |
|---|---|---|---|---|---|---|---|
| Skin Formation Time | min. | 45 | 45 | 45 | 45 | 45 | 30 |

### Physical Properties—Cured Resin Compositions

Test samples of the cured resin compositions were prepared from the resin compositions of EXAMPLES 1-11 and COMPARATIVE EXAMPLE 1, and various physical/mechanical properties of the cured resin compositions were obtained as described below.

The residual tack of the cured resin composition was determined based on a Likert scale of 1 to 8 where the higher number corresponds to lower level of tack, and the residual tack of 8 means there is no tack.

The hardness of the cured resin compositions was determined by pressing a durometer against the surface of the cured test samples according to ASTM C661. Type A scale was used to determine the hardness.

The cured test samples having a thickness of 3 mm were cut into dimensions per ASTM D412 and a tensile test was conducted using a Universal tensile testing machine. The test was conducted in accordance with ASTM D412 to obtain a tensile stress at 100% elongation (M100), a tensile strength at break and an elongation at break.

Removability was determined by hand peel evaluation.

The summary of the cured resin composition properties of EXAMPLES 1-11 and COMPARATIVE EXAMPLE 1 are shown in Tables 7, 8, 9 and 10. “Before” and “After” in Table 7, 9 and 10 indicate the results immediately after the sample was made (before) and then results after aging the sample for 4 weeks (after). “AF” means “adhesion failure” and indicates that the cured resin composition may be removed from a substrate by hand-peeling. “CF” means “cohesion failure” and indicates that the cured resin composition may not be removed from a substrate by hand-peeling.

Tables 7, 8, 9 and 10 show that the cured resin compositions of EXAMPLES 1-11 possess a removable adhesion property.

TABLE 7

| | | | Example 1 | | Example 2 | | Example 3 | | Example 4 | |
|---|---|---|---|---|---|---|---|---|---|---|
| | | | 50/50 | | 30/70 | | 50/50 | | 30/70 | |
| | | | Before | After | Before | After | Before | After | Before | After |
| Cure in depth | after 1 day | mm | 4.16 | 5.11 | 4.27 | 5.56 | 4.55 | 5.61 | 4.34 | 5.63 |
| | after 7 days | mm | 12.07 | 13.59 | 12.03 | 14.23 | 12.45 | 14.35 | 12.72 | 14.36 |
| Residual tack | after 1 day | | 5 | 5 | 5 | 5 | 4 | 5 | 4 | 5 |
| | after 3 days | | 5 | 6 | 5 | 6 | 5 | 5 | 5 | 5 |
| | after 7 days | | 6 | 6 | 6 | 6 | 5 | 6 | 5 | 6 |
| Hardness (ASTM C661) | | Shore A | 43 | 14 | 12 | 11 | 6 | 7 | 5 | 8 |
| Tensile strength by | M100 | MPa | 0.20 | 0.19 | 0.20 | 0.20 | 0.13 | 0.14 | 0.13 | 0.14 |
| dumbbell shape | TB | MPa | 0.70 | 0.81 | 0.66 | 0.66 | 0.56 | 0.82 | 0.34 | 0.66 |
| (ASTM D412) | EB | % | 660 | 712 | 591 | 606 | 552 | 737 | 339 | 596 |

| | | | | | | | | | |
|---|---|---|---|---|---|---|---|---|---|
| Hand-peeling | on Motar | AF | CF | AF | CF | AF | AF | AF | AF |
| (Dry) | on Ano. Aluminum | AF | AF | AF | AF | AF | AF | AF | AF |
| | on Stainless | AF | AF | AF | AF | AF | AF | AF | AF |
| | on Glass | AF | AF | AF | AF | AF | AF | AF | AF |
| | on PVC | AF | AF | AF | AF | AF | AF | AF | AF |
| | on PC | AF | AF | AF | AF | AF | AF | AF | AF |
| | on ABS | AF | AF | AF | AF | AF | AF | AF | AF |
| | on Pine Wood | AF | AF | AF | AF | AF | AF | AF | AF |

TABLE 8

| | Example 1 | Example 2 | Example 3 | Example 4 |
|---|---|---|---|---|
| Dry | | | | |
| Motar | AF | AF | AF | AF |
| Al | AF | AF | AF | AF |
| Glass | AF | AF | AF | AF |
| Wet | | | | |
| Motar | AF | AF | AF | AF |
| Al | AF | AF | AF | AF |
| Glass | AF | AF | AF | AF |

TABLE 9

| | | | Example 5 | | Example 6 | | Example 7 | | Example 8 | | Example 9 | |
|---|---|---|---|---|---|---|---|---|---|---|---|---|
| | | | 85/15 | | 85/15 w/1124 | | 70/30 w/DAMO | | 70/30 w/1124 | | 70/30 | |
| Cure in | after 1 day | mm | 3.25 | 4.82 | 3.05 | 4.52 | 3.22 | 4.95 | 3.2 | 4.62 | 3.01 | 4.81 |
| depth | after 7 days | mm | 9.65 | 11.79 | 9.31 | 11.35 | 9.43 | 11.6 | 9.45 | 11.72 | 9.53 | 11.75 |
| Residual | after 1 day | | 6 | 5 | 6 | 5 | 6 | 5 | 6 | 5 | 6 | 5 |
| tack | after 3 days | | 6 | 6 | 6 | 6 | 6 | 6 | 6 | 6 | 6 | 6 |
| | after 7 days | | 6 | 6 | 6 | 6 | 6 | 6 | 6 | 6 | 6 | 6 |
| Hardness (ASTM C661) | | Shore A | 20 | 19 | 25 | 16 | 23 | 17 | 19 | 15 | 16 | 10 |
| Tensile | M100 | MPa | 0.24 | 0.24 | 0.28 | 0.27 | 0.29 | 0.3 | 0.25 | 0.26 | 0.22 | 0.2 |
| strength | TB | MPa | 0.77 | 0.77 | 0.82 | 0.8 | 0.85 | 0.84 | 0.79 | 0.77 | 0.78 | 0.77 |
| by | EB | % | 705 | 684 | 578 | 581 | 678 | 668 | 578 | 581 | 704 | 713 |
| dumbbell | | | | | | | | | | | | |
| shape | | | | | | | | | | | | |
| (ASTM | | | | | | | | | | | | |
| D412) | | | | | | | | | | | | |

| | | | | | | | | | | | |
|---|---|---|---|---|---|---|---|---|---|---|---|
| Hand- | on Motar | CF | CF | CF | CF | CF | CF | CF | CF | AF | CF |
| peeling | on Ano. Aluminum | AF | AF | AF | CF | AF | AF | AF | CF | AF | AF |
| (Dry) | on Stainless | AF | AF | AF | AF | CF | AF | AF | AF | AF | AF |
| | on Glass | AF | AF | CF | AF | AF | CF | AF | AF | AF | AF |
| | on PVC | AF | AF | AF | AF | AF | AF | AF | AF | AF | AF |
| | on PC | AF | AF | AF | AF | AF | AF | AF | AF | AF | AF |
| | on ABS | AF | AF | AF | AF | AF | AF | AF | AF | AF | AF |
| | on Pine Wood | AF | AF | TF | AF | AF | AF | AF | AF | AF | AF |

TABLE 10

| | | | Comparative example 1 | | Example 10 | | Example 11 | |
|---|---|---|---|---|---|---|---|---|
| | | | Before | After | Before | After | Before | After |
| Cure in depth | after 1 day | mm | 3.16 | 3.5 | 3.71 | 4.05 | 3.91 | 4.23 |
| | after 7 days | mm | 8.13 | 10.82 | 9.36 | 11.68 | 9.42 | 12.44 |
| Residual tack | after 1 day | | 7 | 5 | 7 | 5 | 7 | 5 |
| | after 3 days | | 7 | 6 | 7 | 6 | 7 | 6 |
| | after 7 days | | 7 | 7 | 7 | 7 | 7 | 7 |
| Hardness (ASTM C661) | | Shore A | 33 | 39 | 28 | 28 | 26 | 28 |
| Tensile strength | M100 | MPa | 1.01 | 1 | 0.33 | 0.32 | 0.25 | 0.27 |
| dumbbell shape | TB | MPa | 1.24 | 1.21 | 0.85 | 0.79 | 0.79 | 0.84 |
| (ASTM D412) | EB | % | 184 | 167 | 592 | 632 | 654 | 713 |

| | | | | | | | |
|---|---|---|---|---|---|---|---|
| Hand-peeling | on Motar | CF | CF | CF | CF | CF | CF |
| (Dry) | on Ano. Aluminum | CF | CF | AF | CF | AF | CF |
| | on Stainless | CF | CF | AF | AF | AF | AF |
| | on Glass | CF | CF | CF | CF | AF | AF |
| | on PVC | CF | CF | AF | AF | AF | AF |
| | on PC | CF | CF | AF | AF | AF | AF |
| | on ABS | CF | CF | AF | AF | AF | AF |
| | on Pine Wood | CF | CF | AF | CF | AF | CF |

The summary of the cured resin composition properties of Examples 1-11 and Comparative example 1 are shown in Table 11 to show a balance of adhesion strength and adhesion failure profile in 48 hours and 7 days after the sample was made. “AF” means “adhesion failure” and indicates that the cured resin composition may be removed from a substrate by hand-peeling. “CF” means “cohesion failure” and indicates that the cured resin composition may not be removed from a substrate by hand-peeling. “B”, “−” and “+” indicate level of difficulty of removal. The profile of the level of adhesion in Table 11 is showed as CF>AF/B+>AF/B>AF/B->AF to have practical implications. In the profile, the B & +/−factors are introduced to indicate the level of difficulty of removal (associated with peel strength). Thus in the scale profile between CF and AF, the level of adhesion ranges from CF>AF/B+>AF/B>AF/B->AF, where CF indicates Cohesive Failure, and AF indicates Adhesion Failure.

TABLE 11

| | | Example 5 | Example 6 | Example 7 | Example 8 | Example 9 |
|---|---|---|---|---|---|---|
| | Dry | 85/15 | 85/15 + 1124 | 70/30 + DAMO | 70/30 + 1124 | 70/30 |
| 48 hrs | Mortar | AF/B+ | AF/B+ | CF | AF/B+ | AF/B+ |
| | Al | AF/B | AF/B | AF/B | AF/B+ | AF/B |
| | Glass | AF/B | AF/B+ | AF/B | AF/B | AF/B |
| | Dry | Example 5 | Example 6 | Example 7 | Example 8 | Example 9 |
| 7 Days | Mortar | AF/B | AF/B+ | AF/B+ | AF/B+ | AF/B |
| | Al | AF/B+ | CF | AF/B+ | AF/B | AF/B− |
| | Glass | AF/B− | AF/B | AF/B | AF/B− | AF/B− |

Table 12 shows 180° peel strength test. The test was conducted in accordance with ASTM D903 to confirm that the peel strength data is consistent with adhesion profile evaluation.

TABLE 12

| | Comparative example 1 | | Example 1 | | Example 5 | | Example 8 | | Example 10 | | Example 11 | |
|---|---|---|---|---|---|---|---|---|---|---|---|---|
| Mortar | 9.14 | CF | 8.56 | AF | 10.41 | AF | 9.03 | CF | 12.21 | CF | 11.07 | CF |
| Wood (Beech) | 10.66 | CF | 0.96 | AF | 0.28 | AF | 0.44 | AF | 0.75 | AF | 0.92 | AF |
| Glass | 9.18 | CF | 0 | AF | 0.55 | AF | 0.22 | AF | 2.32 | AF | 0.61 | AF |
| on Ano. Aluminum | 9.59 | CF | 1.32 | AF | 5.58 | AF | 2.13 | AF | 5.56 | AF | 11.97 | CF |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A curable resin composition comprising:
at least one moisture curable resin; and
at least one polyol plasticizer comprising at least one ethylene oxide moiety.

2. The curable resin composition of claim 1, wherein the at least one moisture curable resin comprises reactive silicon groups represented by the general formula (I): 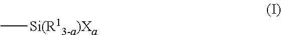
wherein R¹ represents an alkyl group having 1 to 20 carbon atoms, an aryl group having 6 to 20 carbon atoms, or an aralkyl group having 7 to 20 carbon atoms,
wherein X represents a hydrolyzable group, wherein each X is the same or different when two or more X are present,
a is an integer from 1 to 3, when a is 1, each R¹ may be the same or different, and
when a is 2 or 3, each X may be the same or different.

3. The curable resin composition of claim 1, wherein the at least one moisture curable resin comprises a silyl-terminated polyether a silyl-terminated polyurethane, or a silane modified polymer.

4. The curable resin composition of claim 1, wherein the ethylene oxide moiety is located along the polymer chain.

5. The curable resin composition of claim 1, wherein the ethylene oxide moiety is located at a terminal end of the polymer chain.

6. The curable resin composition of claim 1, wherein the polyol plasticizer has a hydroxyl number in a range from 10 to 400 mg·KOH/g. The curable resin composition of any one of the above claims, wherein the polyol plasticizer has an average molecular weight of 500 to 10,000 Da.

7. The curable resin composition of claim 1, wherein a combined content of the at least one moisture curable resin and the polyol plasticizer is in a range of 10 wt % to 90 wt % of the curable resin composition.

8. The curable resin composition of claim 1, further comprising an additional plasticizer.

9. The curable resin composition of claim 8, wherein the additional plasticizer is selected from the group consisting of a polyol, a phthalate or non-phthalate ester.

10. The curable resin composition of claim 1, further comprising an additive selected from the group consisting of a filler, a pigment, a thixotropic agent, a UV inhibitor, a UV absorber, a stabilizer, a dehydration agent, an adhesion promoter, a flame retardant, a curability modifier, a lubricant, a surfactant, and an antifungal agent.

11. The curable resin composition of claim 10, wherein the amount of adhesion promoter is less than 0.8 wt % of the curable resin composition.

12. A cured resin composition of the curable resin composition of claim 1.

13. The cured resin composition of claim 12, having a removable adhesion property.

14. A structure, comprising:
a substrate; and
a coating disposed on the substrate,
wherein the coating comprises at least one layer of the cured resin composition of claim 12.

15. A method for producing a curable resin composition, comprising:
mixing 5 wt % to 70 wt % of at least one moisture curable resin, and 0.5 wt % to 40 wt % of a polyol plasticizer.

16. A method, comprising:
applying a curable resin composition of claim 1 onto a substrate.

17. The method of claim 16, further comprising:
exposing the applied curable resin composition to moisture; and
curing the applied curable resin composition to produce a cured resin composition of the curable resin composition.

18. The method of claim 16, further comprising:
removing the cured resin composition from the substrate such that a visible residue does not remain on the substrate after removing.

19. A method of adjusting a removable adhesion property of a curable resin composition from a substrate comprising:
mixing 5 wt % to 70 wt % of at least one moisture curable resin, and 0.5 wt % to 40 wt % of a polyol plasticizer,
such that a visible residue does not remain on the substrate after removal of the curable resin composition.

20. The method of claim 18, further comprising less than 0.8 wt % of an adhesion promoter.
